(19) United States
(12) Patent Application Publication
(10) Pub. No.: US 2024/0075791 A1
(43) Pub. Date: Mar. 7, 2024

(54) PREDICTING HEATING, VENTILATION, AND AIR CONDITIONING FAILURE

(71) Applicant: GM Cruise Holdings LLC, San Francisco, CA (US)

(72) Inventors: Luke McDermott, Houston, TX (US); David Tran, San Francisco, CA (US); Diana Cabral, San Francisco, CA (US); Zacharie Esmili, San Francisco, CA (US)

(21) Appl. No.: 17/903,219

(22) Filed: Sep. 6, 2022

(51) Int. Cl. B60H 1/00; G06Q 10/00; H01M 10/613; H01M 10/625; H01M 10/633; H01M 10/663

(52) U.S. Cl. CPC B60H 1/00978; G06Q 10/20; H01M 10/613; H01M 10/625; H01M 10/633; H01M 10/663; H01M 2220/20

(57) ABSTRACT

Aspects of the subject technology relate to systems, methods, and computer-readable media for maintaining a heating, ventilation, and air conditioning (HVAC) system in a vehicle. Factors associated with operation of an HVAC system in a vehicle are monitored. Input data generated by monitoring the factors are applied to a machine learning model. The machine learning model is configured to predict a health of the HVAC system in relation to the operation of the HVAC system in the vehicle. An output of the machine learning model that is indicative of the health of the HVAC system is accessed. Information associated with a likelihood that the HVAC system will fail in relation to a specific time is identified based on the output of the machine learning model.

### BACKGROUND

### 1. Technical Field

The present disclosure generally relates to maintaining a heating, ventilation, and air conditioning (HVAC) system in a vehicle and, more specifically, to predicting a likelihood of HVAC failure in the vehicle.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

HVAC systems are used to control temperatures in a vehicle cabin and temperatures of various components of the vehicle. HVAC systems are prone to failure and can be subjected to maintenance during the life of a vehicle. Often, maintenance is not performed on a vehicle HVAC system until the HVAC system has completely failed. Other times, maintenance is performed at a service interval that is set by the manufacturer irrespective of the operating conditions of the vehicle. Therefore, the HVAC system can be serviced before maintenance is actually needed or well past a point where maintenance should have been performed and the HVAC system has completely failed. These problems associated with HVAC system maintenance in vehicles are further exacerbated in autonomous vehicles, which lack an in-vehicle operator that can detect performance degradation of an HVAC system.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some examples of the present disclosure;

FIG. 2 illustrates a flowchart for an example method of predicting a likelihood of HVAC system failure through application of a machine learning model, according to some examples of the present disclosure;

FIG. 3 illustrates an example environment in which maintenance of HVAC systems in a fleet of vehicles is managed based on operation of the HVAC systems in the fleet of vehicles, according to some examples of the present disclosure;

FIG. 4 illustrates a flowchart for an example method of facilitating maintenance of an HVAC system based on an identified likelihood that the HVAC system will fail, according to some examples of the present disclosure;

FIG. 5 is an example of a deep learning neural network, according to some examples of the present disclosure; and

FIG. 6 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As discussed previously, HVAC systems are used to control temperatures in a vehicle cabin and temperatures of various components of the vehicle. HVAC systems are prone to failure and can be subjected to maintenance during the life of a vehicle. Often, maintenance is not performed on a vehicle HVAC system until the HVAC system has completely failed. Other times, maintenance is performed at a service interval that is set by the manufacturer irrespective of the operating conditions of the vehicle. Therefore, the HVAC system can be serviced before maintenance is actually needed or well past a point where maintenance should have been performed and the HVAC system has completely failed.

These problems associated with HVAC system maintenance in vehicles are further exacerbated in autonomous vehicles for a number of reasons. Specifically, autonomous vehicles lack an in-vehicle operator that can detect performance degradation of an HVAC system. Further, autonomous vehicles have onboard computing components that require significant cooling, making stable HVAC system operation crucial for autonomous vehicle operation. In turn, this can placed increased demands on the HVAC systems in actually operating to cool components of the autonomous vehicles.

The disclosed technology addresses the problems associated with maintaining HVAC systems in vehicles by applying a machine learning model to predict a likelihood that the HVAC systems will fail within a specific time or reference frame. More specifically, the disclosed technology includes monitoring factors associated with operation of an HVAC system and applying the results of such monitoring to a machine learning model to predict information associated with a likelihood that the HVAC system will fail.

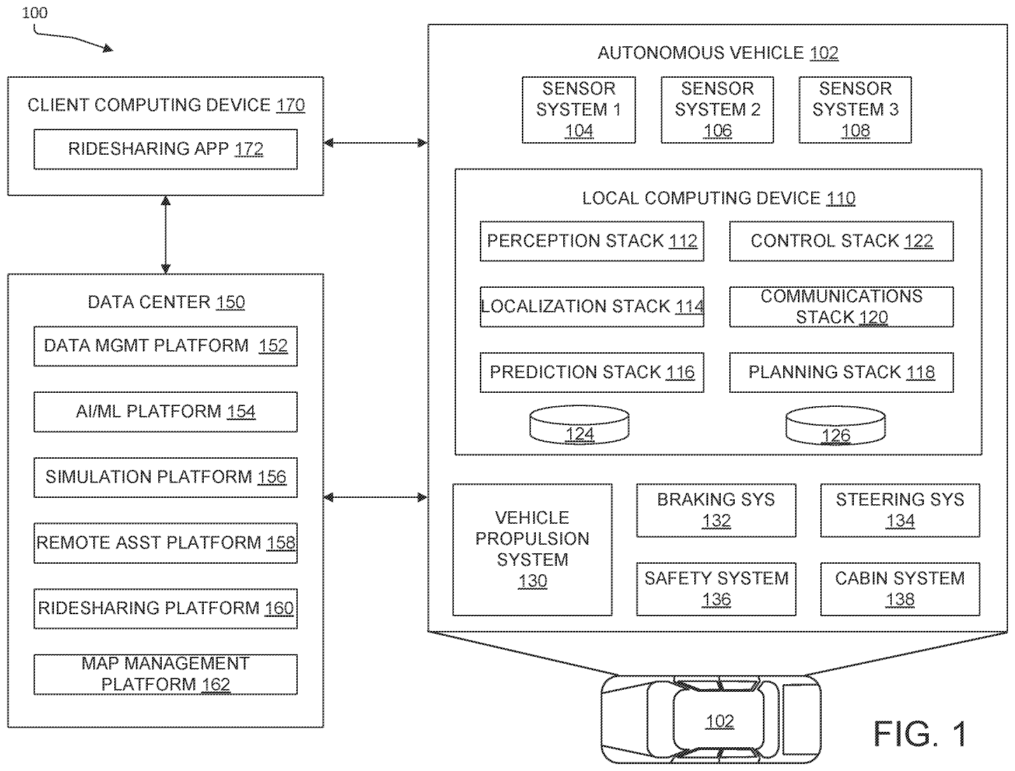

FIG. 1 is a diagram illustrating an example autonomous vehicle (AV) environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill in the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUS, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

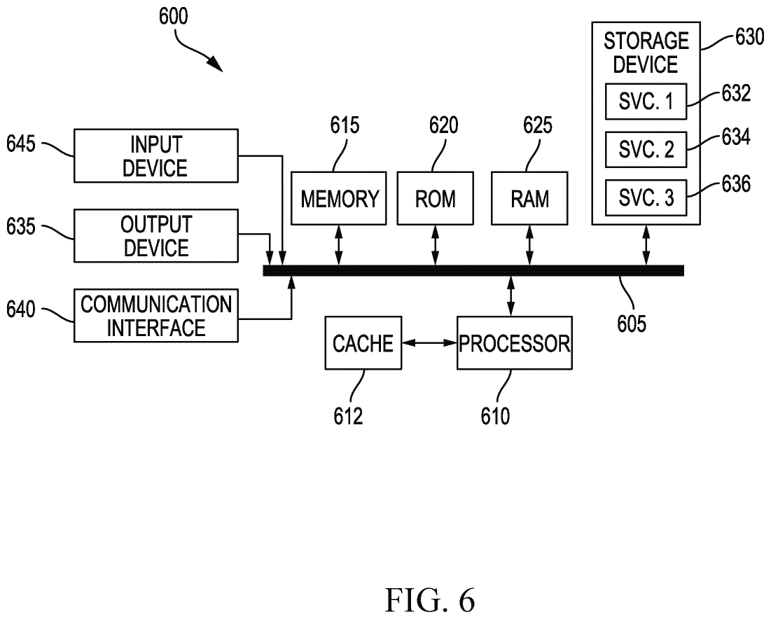

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

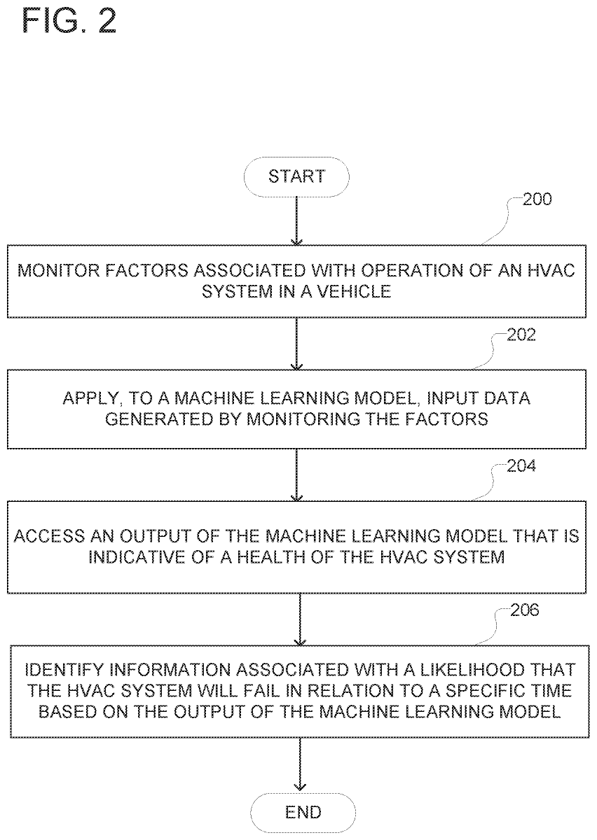

The disclosure now continues with a discussion of techniques for predicting a likelihood of HVAC system failure in a vehicle in order to maintain the HVAC system. Specifically, FIG. 2 illustrates a flowchart for an example method of predicting a likelihood of HVAC system failure through application of a machine learning model. The method shown in FIG. 2 is provided by way of example, as there are a variety of ways to carry out the method. Additionally, while the example method is illustrated with a particular order of steps, those of ordinary skill in the art will appreciate that FIG. 2 and the modules shown therein can be executed in any order and can include fewer or more modules than illustrated. Each module shown in FIG. 2 represents one or more steps, processes, methods or routines in the method.

At step 200, factors associated with operation of an HVAC system in a vehicle are monitored. Factors associated with operation of an HVAC system in a vehicle include applicable parameters that are related to the operation of an HVAC system in the vehicle. Specifically, factors associated with operation of an HVAC system can include factors that directly affect the operation of the HVAC system. More specifically, a factor associated with operation of an HVAC system can include an applicable performance indicator of an HVAC system. For example, a factor associated with operation of an HVAC system can include a temperature of an evaporator of the HVAC system. In another example, a factor associated with operation of an HVAC system can include a rate at which the HVAC system draws power from a battery. Further, factors associated with operation of an HVAC system in a vehicle can include factors, e.g. in the vehicle, that are affected by the operation of the HVAC system. For example, a factor associated with operation of an HVAC system in a vehicle can include a temperature within a cabin of the vehicle. In another example, a factor associated with operation of an HVAC system in a vehicle can include a temperature of a battery of the vehicle that is coupled to the HVAC system.

Factors associated with operation of an HVAC system in a vehicle can include parameters that are capable of being measured by a sensor, e.g. a sensor integrated as part of the vehicle. Examples of sensors that can be used in measuring factors associated with operation of an HVAC system in a vehicle include temperature sensors, humidity sensors, pressure sensors, sunlight sensors, and fluid level sensors. Specifically, factors associated with operation of an HVAC system in a vehicle can include climate parameters of a geographical area in which the vehicle operates that are capable of being measured by one or more sensors. The sensors for measuring climate parameters can be separate from a vehicle. Further, the climate parameter data can be sourced from a resource that is external to, or otherwise separate from, the vehicle. For example, climate parameter data can be generated by a government entity separate from the vehicle.

Further, factors associated with operation of an HVAC system in a vehicle can include parameters related to previous maintenance of the vehicle, e.g. the service history of the vehicle. Specifically, factors associated with operation of an HVAC system in a vehicle can include parameters related to previous maintenance of the HVAC system. For example, a factor associated with operation of an HVAC system in a vehicle can include that an evaporator was replaced in the HVAC system. Parameters related to previous maintenance of a vehicle can have a temporal aspect, e.g. with respect to a present time. For example, parameters related to previous maintenance of a vehicle can include that a refrigerant replacement was performed one year ago.

Additionally, factors associated with operation of an HVAC system in a vehicle can include parameters related to characteristics of how the vehicle is operated. Specifically, factors associated with operation of an HVAC system in a vehicle can include parameters related to how the vehicle is operated while the HVAC system is utilized. For example, factors associated with operation of an HVAC system in a vehicle can include an amount of time that the HVAC system was run while the vehicle was stopped. In another example, factors associated with operation of an HVAC system in a vehicle can include an amount of time that an engine of the vehicle is operated at an increased load, e.g. operated on hills.

A vehicle can be associated with a group of other vehicles, otherwise referred to as a fleet of vehicles. As follows, factors associated with operation of an HVAC system in the vehicle can include factors characteristics of the other vehicles included in the fleet, e.g. otherwise referred to as fleet characteristics. Fleet characteristics can include applicable factors associated with operation of HVAC systems in vehicles of the fleet. Specifically, fleet characteristics can include any of the factors associated with operation of an HVAC system in a vehicle that are described here. For example, fleet characteristics can include that cars in the fleet are experiencing compressor issues on a hot day. In turn and as will be discussed in greater detail later, the fleet characteristics can be used in predicting a likelihood of a failure of an HVAC system in a vehicle and potentially coordinating maintenance of the HVAC system in the vehicle.

Returning back to the flowchart shown in FIG. 2, at step 202, input data generated by monitoring the factors associated with operating of an HVAC system in a vehicle are applied to a machine learning model. A machine learning model can include an applicable model for predicting a health of the HVAC system in relation to operation of the HVAC system in the vehicle. Health of an HVAC system, as used herein, includes a state of the HVAC system in operating in the vehicle. Specifically, health of an HVAC system can be describable through indicators of performance of the HVAC. For example, a health of an HVAC system can include that the HVAC system is operating in a state of degraded performance. More specifically, a health of the HVAC system can include that the HVAC system is operating at a reduced efficiency with respect to the HVAC system operating at 100% efficiency.

Health of an HVAC system can be describable in relation to components of the HVAC system. Specifically, health of an HVAC system can be described with respect to a state of degraded performance in relation to a status of one or more components of the HVAC system that are related to or caused the state of degraded performance. For example, health of an HVAC system can include that an evaporator and compressor of an HVAC are failing. In another example, health of an HVAC system can include that specific components are operating beyond their expected lifetimes. A lifetime of a component or system, as used herein, can include an applicable temporal measure for describing a lifetime of a component or system. For example, a lifetime of a component or system can be expressed in terms of a number of miles that a vehicle has traveled with the component or system, a number of hours the component or system has been operated, or a duty cycle of the component or system.

Input data can include applicable data that is capable of being generated from factors associated with operation of the HVAC system. In turn, the input data can be applied to a machine learning model to generate output indicative of the health of the HVAC system. The machine learning model can be an applicable model for predicting health of HVAC systems operating in vehicles. Specifically and as will be discussed in greater detail later, the machine learning model can be an applicable model for predicting health of HVAC systems based on factors related to operation of the HVAC systems in vehicles.

Input data that is applied to the machine learning model can include temperature data generated based on the factors associated with the operation of the HVAC system. Specifically, input data can be generated from temperature factors that include operational temperatures of one or more components of either or both the HVAC system and the vehicle. More specifically, input data can be generated from temperature factors that include operational temperatures of the one or more components in relation to corresponding target temperatures of the one or more components.

In generating input data based on temperature factors, the input data can be generated based on a measured temperature of an evaporator of the HVAC system. Specifically, the input data can include a measured evaporator temperature in comparison to a target temperature of the evaporator. In particular, trends of a difference between the actual evaporator temperature and a target evaporator temperature can serve as input to the model. For example, input to the model can include that the difference between an actual temperature of the evaporator and the target evaporator temperature is growing over time, which can be indicative of degrading HVAC system performance. In another example, input to the model can include that the difference between evaporator temperature and target temperature does not decrease after a sufficient amount of time after vehicle startup.

Further, input data that is generated based on temperature factors can be generated based on a measured temperature of computer system components of either or both the vehicle and the HVAC system. Specifically, the input data can include a measured temperature of a printed circuit board (PCB) in comparison to a target temperature of the PCB of a computer system. In particular, trends of a difference between the actual PCB temperature and a target PCB temperature can serve as input to the model. For example, input to the model can include that the difference between an actual temperature of the PCB and the target PCB temperature is growing over time, which can be indicative of degrading HVAC system performance.

Additionally, input data that is generated based on temperature factors can be generated based on a measured temperature of a battery or battery component associated with the HVAC system. Specifically, the input data can include a measured temperature of a battery chiller in comparison to a target temperature of the battery chiller. In another example, the input data can include a measured temperature of a battery itself in comparison to a target temperature of the battery. Trends of a difference between the actual battery or battery component temperature and a target temperature can serve as input to the model. For example, input to the model can include that the difference between an actual temperature of a battery chiller and the target battery chiller temperature is growing over time, which can be indicative of degrading HVAC system performance.

Input data that is applied to the machine learning model can also include pressure data generated based on the factors associated with the operation of the HVAC system. Specifically, input data can be generated from either or both dynamic upper and lower side pressures of the HVAC system. More specifically, input data can be generated based on either or both changing upper and lower side pressures of the HVAC system that are measured by one or more pressure monitors. For example, persistent high-side and/or low-side pressure readings outside of normal operating ranges can be indicative of degrading HVAC system performance. The normal operation ranges of the high-side and low-side pressures can be defined by applicable factors including outside temperature factors, humidity factors, and other location specific climate factors.

Further, input data that is applied to the machine learning model can include an amount of power, e.g. battery power, that is used in operating the HVAC system. Specifically, the input data can be generated based on an amount of power, e.g. battery power, that is used in achieving a corresponding target temperature of one or more components over time. For example, the input data can be generated based on the power draw of the HVAC system in achieving a target temperature of the cab of the vehicle over time. In turn, an increased power draw of the HVAC system in achieving a target temperature over time can be indicative of failing components in the HVAC system.

Input data can also include environmental data. Environmental data includes applicable information describing an environment surrounding the vehicle either currently or in the past. Specifically, environmental data can include climate data describing current weather surrounding the vehicle. For example, environmental data can include data describing temperature and humidity levels around the vehicle. Further, input data can include geographical data indicative of routes and positions occupied by the vehicle. For example, geographic data can indicate a city or neighbor where the vehicle operates.

Additionally, input data can include operational data related to actual operation of the vehicle. Operational data of the vehicle can include service history of the vehicle. Further, operational data can include an amount the vehicle has been driven, accumulated miles of the vehicle, and duty cycles of components of the vehicle, e.g. since the last servicing of the vehicle.

Returning back to the flowchart shown in FIG. 2, at step 204, an output of the machine learning model is accessed. The output is indicative of the health of the HVAC system. In indicating the health of the HVAC system, the output can include data related to a likelihood that the HVAC system will fail, e.g. with reference to a specific time or time interval. For example, the output can include data indicating that the HVAC system has a 20% chance of failure within the next two months.

Output of the machine learning model can be indicative of failure or potential failure on a component level of granularity. Specifically, input can include that particular errors are occurring which indicate that a specific component is failing. In turn, the machine learning model can identify the failing of the specific component and a chance that the component will completely fail within a certain time frame. For example, input to the machine learning model can include that a compressor was recently replaced in the HVAC system. Further, the input can indicate that the refrigerant is not properly cooling air by the HVAC system. As follows, the machine learning model can generate output based on the input data that indicates a refrigerant issue is present since the compressor was just replaced.

The machine learning model can use cluster analysis in generating the output that is accessed at step 204. Specifically, the machine learning model can use cluster analysis to identify components of the HVAC system that are failing or are likely to fail. Specifically, the machine learning model can perform cluster analysis on the input to identify a subset of different components of the HVAC system that are failing or likely to fail. For example, the machine learning model can apply cluster analysis to generate output indicative of a 10% chance of compressor related component failure in the HVAC system.

Output of the machine learning model that is generated from the input can be indicative of a severity of a failure or a potential failure. A severity of a failure or potential failure can be selected from a group of different severity levels or defined severity thresholds. Severity, as used herein, is indicative of an effect of a failure or a potential failure on the overall operation of the HVAC system. For example, a severity can include a low severity level that corresponds to small performance degradation of the HVAC system, e.g. relative to a threshold performance level. In another example, a severity can include a medium severity level that corresponds to significant performance degradation of the HVAC system, e.g. relative to a threshold performance level. In yet another example, a severity can include a high severity level that corresponds to a catastrophic performance degradation of the HVAC system, e.g. relative to a threshold performance level.

As shown by this description, there are a large number of parameters that can serve as input for predicting failure of an HVAC system. Further, output related to predicting failure of an HVAC system can vary in both its specificity and accuracy. Accordingly, this makes it difficult for a human operator associated with a vehicle to accurately predict a likelihood of HVAC failure at a component level of granularity. This becomes more difficult when the operator is remote during operation of the vehicle, as is the case for AVs, and when the operator is managing a fleet of vehicles. Therefore, the technology described herein offers advantages that a human operator in predicting HVAC failure is unable to achieve.

At step 206, information associated with a likelihood that the HVAC system will fail is identified based on the output of the machine learning model that is accessed at step 204. In particular, information associated with a likelihood that the HVAC system will fail in relation to a specific time or time frame is identified based on the output of the machine learning model. The information associated with a likelihood that the HVAC system will fail can include applicable information that is either included as part of the output of the machine learning model or is identifiable from the output of the machine learning model. For example, the information associated with a likelihood that the HVAC system will fail can include a probability that the HVAC system will fail within a specific time frame. In another example, the information can include a severity level of identified or predicted failures that are occurring or will occur during operation of the HVAC system.

The information associated with a likelihood that the HVAC system will fail can include an identification of a component of the HVAC system that should be maintained in correcting a failure or potential failure of the HVAC system. The identification of the component can be determined from the output of the machine learning model. Specifically, the identification of the component can be determined from the output of the machine learning model based on the factors associated with the operation of the HVAC system. For example, the output of the machine learning model can indicate that there is a 50% change of a catastrophic failure of the HVAC system. Further in the example, the factors associated with the operation of the HVAC system can include that the high-side pressure is outside of a normal range. In turn, it can be determined that the compressor needs to be replaced based on this output of the machine learning model and the factor that the high-side pressure is outside of the normal range. The machine learning model itself can determine the component of the HVAC system that should be maintained in correcting a failure or potential failure of the HVAC system.

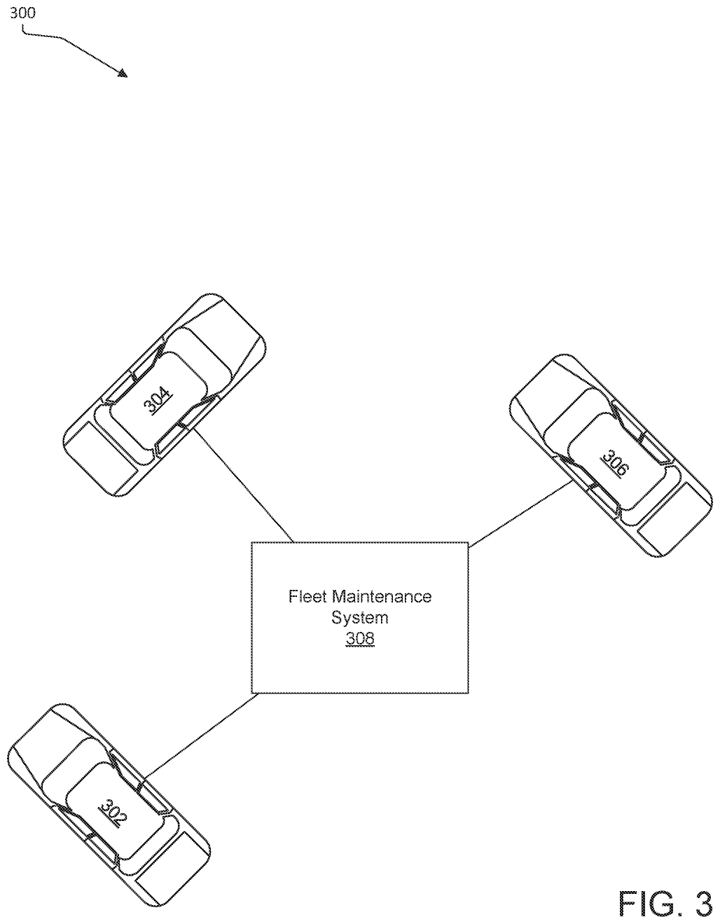

The technology described herein for implementing machine learning to predict HVAC system failure based on factors associated with the operation of the HVAC system of a vehicle can be performed as part monitoring a fleet of vehicles including the vehicle. Specifically, FIG. 3 illustrates an example environment 300 in which maintenance of HVAC systems in a fleet of vehicles is managed based on operation of the HVAC systems in the fleet of vehicles. The environment shown in FIG. 3 includes a first vehicle 302, a second vehicle 304, a third vehicle 306, and a fleet maintenance system 308. The first, second, and third vehicles 302, 304, and 306 can form a fleet, or otherwise group of associated vehicles. The group of vehicles 302, 304, and 306 can be grouped into the fleet based on applicable shared factors, e.g. shared factors associated with operation of corresponding HVAC systems. For example, the vehicles 302, 304, and 306 can be grouped together based on their operation in the same geographical area. In another example, the vehicles 302, 304, and 306 can be grouped together based on similar service histories.

The fleet maintenance system 308 functions to manage maintenance of the vehicles 302, 304, and 306 as part of managing maintenance of the fleet formed by the vehicles 302, 304, and 306. The fleet maintenance system 308 can be implemented separate, at least in part, from the fleet. In turn the fleet maintenance system 308 can remotely manage the fleet. For example, the first, second, and third vehicles 302, 304, and 306 can be AVs that are managed remotely by the fleet maintenance system 308 implemented at a central control system.

In managing maintenance of the vehicles 302, 304, and 306, the fleet maintenance system 308 can communicate with the vehicles 302, 304, and 306. Specifically, the fleet maintenance system 308 can receive or otherwise access data related to operation of corresponding HVAC systems in the vehicles 302, 304, and 306. In turn, the fleet maintenance system 308 can manage maintenance of the HVAC systems in the vehicles 302, 304, and 306 based on operation of the HVAC systems across the fleet. For example, the fleet maintenance system 308 can identify a likelihood that the HVAC system will fail in the first vehicle 302 based on operation of the HVAC systems in the second and third vehicles 304 and 306. Further in the example, if the HVAC systems in the second and third vehicles 304 and 306 underwent refrigerant replacement, then the fleet maintenance system 308 can determine that the HVAC system in the first vehicle 302 should have its refrigerant replaced.

In managing maintenance of HVAC systems in a fleet of vehicles, the fleet maintenance system 308 can apply the techniques described herein. Specifically, the fleet maintenance system 308 can apply input to a machine learning model to predict a likelihood of failure in HVAC systems in the fleet. Information associated with operation of the HVAC systems in the fleet can serve as input data to the machine learning model. In turn, this input can be used to identify information associated with a likelihood that different HVAC systems in the fleet will fail.

In managing maintenance of HVAC systems in the fleet, the fleet maintenance system 308 can facilitate maintenance of the vehicles in the fleet. Specifically, and as will be discussed in greater detail later, the fleet maintenance system 308 can coordinate maintenance with an entity responsible for maintaining vehicles in the fleet. For example, the fleet maintenance system 308 can take a vehicle out of service and direct the vehicle to repair shop. Specifically, the fleet maintenance system 308 can generate routing instructions for driving the vehicle to the repair shop. In the case where the vehicle is an AV, the routing instructions for the AV can include AV controls for controlling the operations and/or driving of the AV to a maintenance location.

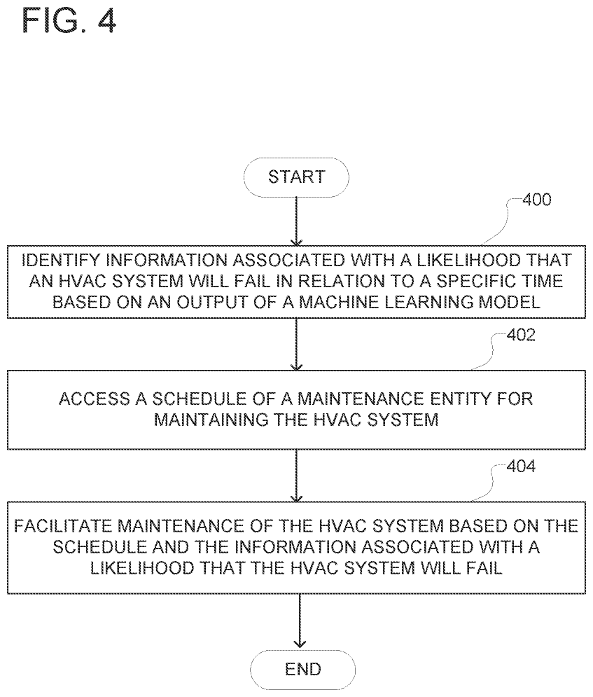

The disclosure now continues with a discussion of techniques for facilitating maintenance of an HVAC system in a vehicle based on an identified likelihood that the HVAC system will fail. Specifically, FIG. 4 illustrates a flowchart for an example method of facilitating maintenance of an HVAC system based on an identified likelihood that the HVAC system will fail. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method.

At step 400, information associated with a likelihood that an HVAC system will fail is identified based on an output of a machine learning model. The HVAC system can include an HVAC system in an AV. The information can be identified based on the techniques described herein. Specifically, the information can be identified based on monitored conditions associated with operation of the HVAC system.

At step 402, a schedule of a maintenance entity for maintaining the HVAC system is accessed. A maintenance entity can be an applicable entity for maintaining the HVAC system. For example, the maintenance entity can be an entity for servicing the vehicle. The schedule can be accessed by an applicable system for managing maintenance for a vehicle, such as the fleet maintenance system 308.

At step 404, maintenance of the HVAC system is facilitated based on the schedule and the information associated with a likelihood that the HVAC system will fail. Facilitating maintenance of the HVAC system, as used herein, includes applicable actions that are performed to carry out maintenance of the HVAC system. Examples of such actions include, scheduling maintenance, directing the vehicle to a location for performing the maintenance, and coordinating other applicable aspects related to maintenance. For example, facilitating maintenance of the HVAC system can include selecting a time for maintenance and actually scheduling the maintenance.

In facilitating maintenance of the HVAC system based on the schedule of the maintenance entity and the likelihood of failure, the maintenance can be scheduled and performed based on a severity of a predicted or identified failure. For example, if the failure is a low severity, then the vehicle can be schedule for inspection and kept in operation until next downtime. In another example, if the failure is a high severity with serious performance degradation, then the vehicle can be controlled for removal from the road after a current ride ends. In yet another example, if the failure is an extreme severity with catastrophic performance degradation, then the vehicle can be shut down immediately.

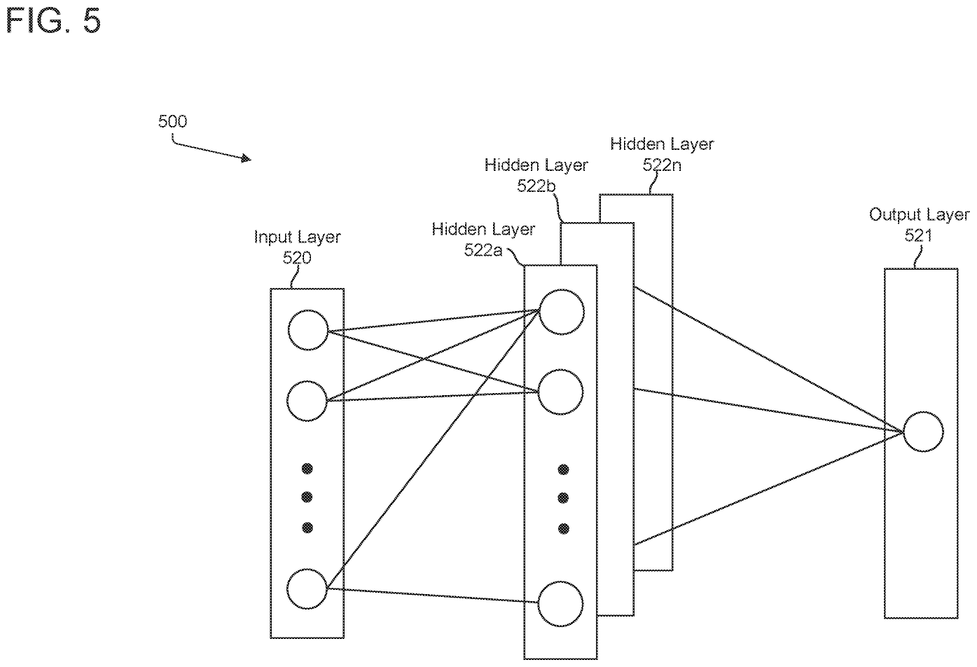

In FIG. 5, the disclosure now turns to a further discussion of models that can be used through the environments and techniques described herein. FIG. 5 is an example of a deep learning neural network 500 that can be used to implement all or a portion of the systems and techniques described herein. An input layer 520 can be configured to receive sensor data and/or data relating to an environment surrounding an AV. The neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. The neural network 500 further includes an output layer 521 that provides an output resulting from the processing performed by the hidden layers 522a, 522b, through 522n. In one illustrative example, the output layer 521 can provide estimated treatment parameters, that can be used/ingested by a differential simulator to estimate a patient treatment outcome.

The neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: monitoring factors associated with operation of a heating, ventilation, and air conditioning (HVAC) system in a vehicle; applying, to a machine learning model, input data generated by monitoring the factors associated with the operation of the HVAC system in the vehicle, wherein the machine learning model is configured to predict a health of the HVAC system in relation to the operation of the HVAC system in the vehicle; accessing an output of the machine learning model that is indicative of the health of the HVAC system; and identifying information associated with a likelihood that the HVAC system will fail in relation to a specific time based on the output of the machine learning model.

Aspect 2. The method of Aspect 1, further comprising: accessing a schedule of a maintenance entity for maintaining the HVAC system; and facilitating maintenance of the HVAC system based on the schedule of the maintenance entity and the information associated with the likelihood that the HVAC system will fail.

Aspect 3. The method of Aspects 1 and 2, wherein the factors associated with operation of the HVAC system include a corresponding operational temperature of one or more components in relation to a corresponding target temperature of the one or more components during the operation of the HVAC system.

Aspect 4. The method of Aspects 1 through 3, wherein the one or more components include an evaporator of the HVAC system, a battery chiller of a battery of the vehicle, a circuit of a computer system of the vehicle, or a combination thereof.

Aspect 5. The method of Aspects 1 through 4, wherein the factors associated with operation of the HVAC system include an amount of battery power used in achieving the corresponding target temperature of the one or more components over time.

Aspect 6. The method of Aspects 1 through 5, wherein the vehicle is part of a group of associated vehicles and the factors associated with operation of the HVAC system include factors associated with operation of HVAC systems of other vehicles in the group of associated vehicles.

Aspect 7. The method of Aspects 1 through 6, wherein the group of associated vehicles is defined to include vehicles based on geographic similarity between locations of the vehicles.

Aspect 8. The method of Aspects 1 through 7, wherein the information associated with the likelihood that the HVAC system will fail includes an identification of a component of the HVAC system for maintenance in correcting a potential failure in the HVAC system, the method further comprising: identifying the component of the HVAC system based on the factors associated with operation of the HVAC system from the output of the machine learning model.

Aspect 9. The method of Aspects 1 through 8, wherein the information associated with the likelihood that the HVAC system will fail includes a severity level of a potential failure in the HVAC system.

Aspect 10. The method of Aspects 1 through 9, wherein the vehicle is an autonomous vehicle.

Aspect 11. A system comprising: one or more processors; and at least one computer-readable storage medium having stored therein instructions which, when executed by the one or more processors, cause the one or more processors to: monitor factors associated with operation of a heating, ventilation, and air conditioning (HVAC) system in a vehicle; apply, to a machine learning model, input data generated by monitoring the factors associated with the operation of the HVAC system in the vehicle, wherein the machine learning model is configured to predict a health of the HVAC system in relation to the operation of the HVAC system in the vehicle; access an output of the machine learning model that is indicative of the health of the HVAC system; and identify information associated with a likelihood that the HVAC system will fail in relation to a specific time based on the output of the machine learning model.

Aspect 12. The system of Aspect 11, wherein the instructions further cause the one or more processors to: access a schedule of a maintenance entity for maintaining the HVAC system; and facilitate maintenance of the HVAC system based on the schedule of the maintenance entity and the information associated with the likelihood that the HVAC system will fail.

Aspect 13. The system of Aspects 11 and 12, wherein the factors associated with operation of the HVAC system include a corresponding operational temperature of one or more components in relation to a corresponding target temperature of the one or more components during the operation of the HVAC system.

Aspect 14. The system of Aspects 11 through 13, wherein the one or more components include an evaporator of the HVAC system, a battery chiller of a battery of the vehicle, a circuit of a computer system of the vehicle, or a combination thereof.

Aspect 15. The system of Aspects 11 through 14, wherein the factors associated with operation of the HVAC system include an amount of battery power used in achieving the corresponding target temperature of the one or more components over time.

Aspect 16. The system of Aspects 11 through 15, wherein the vehicle is part of a group of associated vehicles and the factors associated with operation of the HVAC system include factors associated with operation of HVAC systems of other vehicles in the group of associated vehicles.

Aspect 17. The system of Aspects 11 through 16, wherein the group of associated vehicles is defined to include vehicles based on geographic similarity between locations of the vehicles.

Aspect 18. The system of Aspects 11 through 17, wherein the information associated with the likelihood that the HVAC system will fail includes an identification of a component of the HVAC system for maintenance in correcting a potential failure in the HVAC system, and the instructions further cause the one or more processors to: identify the component of the HVAC system based on the factors associated with operation of the HVAC system from the output of the machine learning model.

Aspect 19. The systems of Aspects 11 through 18 wherein the information associated with the likelihood that the HVAC system will fail includes a severity level of a potential failure in the HVAC system.

Aspect 20. A non-transitory computer-readable storage medium having stored therein instructions which, when executed by one or more processors, cause the one or more processors to: monitor factors associated with operation of a heating, ventilation, and air conditioning (HVAC) system in a vehicle; apply, to a machine learning model, input data generated by monitoring the factors associated with the operation of the HVAC system in the vehicle, wherein the machine learning model is configured to predict a health of the HVAC system in relation to the operation of the HVAC system in the vehicle; access an output of the machine learning model that is indicative of the health of the HVAC system; and identify information associated with a likelihood that the HVAC system will fail in relation to a specific time based on the output of the machine learning model.

Aspect 21. A system comprising means for performing a method according to any of Aspects 1 through 10.

What is claimed is:

1. A method comprising:
monitoring factors associated with operation of a heating, ventilation, and air conditioning (HVAC) system in a vehicle;
applying, to a machine learning model, input data generated by monitoring the factors associated with the operation of the HVAC system in the vehicle, wherein the machine learning model is configured to predict a health of the HVAC system in relation to the operation of the HVAC system in the vehicle;
accessing an output of the machine learning model that is indicative of the health of the HVAC system; and
identifying information associated with a likelihood that the HVAC system will fail in relation to a specific time based on the output of the machine learning model.

2. The method of claim 1, further comprising:
accessing a schedule of a maintenance entity for maintaining the HVAC system; and
facilitating maintenance of the HVAC system based on the schedule of the maintenance entity and the information associated with the likelihood that the HVAC system will fail.

3. The method of claim 1, wherein the factors associated with operation of the HVAC system include a corresponding operational temperature of one or more components in relation to a corresponding target temperature of the one or more components during the operation of the HVAC system.

4. The method of claim 3, wherein the one or more components include an evaporator of the HVAC system, a battery chiller of a battery of the vehicle, a circuit of a computer system of the vehicle, or a combination thereof.

5. The method of claim 3, wherein the factors associated with operation of the HVAC system include an amount of battery power used in achieving the corresponding target temperature of the one or more components over time.

6. The method of claim 1, wherein the vehicle is part of a group of associated vehicles and the factors associated with operation of the HVAC system include factors associated with operation of HVAC systems of other vehicles in the group of associated vehicles.

7. The method of claim 6, wherein the group of associated vehicles is defined to include vehicles based on geographic similarity between locations of the vehicles.

8. The method of claim 1, wherein the information associated with the likelihood that the HVAC system will fail includes an identification of a component of the HVAC system for maintenance in correcting a potential failure in the HVAC system, the method further comprising:
identifying the component of the HVAC system based on the factors associated with operation of the HVAC system from the output of the machine learning model.

9. The method of claim 1, wherein the information associated with the likelihood that the HVAC system will fail includes a severity level of a potential failure in the HVAC system.

10. The method of claim 1, wherein the vehicle is an autonomous vehicle.

11. A system comprising:
one or more processors; and
at least one computer-readable storage medium having stored therein instructions which, when executed by the one or more processors, cause the one or more processors to:
monitor factors associated with operation of a heating, ventilation, and air conditioning (HVAC) system in a vehicle;
apply, to a machine learning model, input data generated by monitoring the factors associated with the operation of the HVAC system in the vehicle, wherein the machine learning model is configured to predict a health of the HVAC system in relation to the operation of the HVAC system in the vehicle;
access an output of the machine learning model that is indicative of the health of the HVAC system; and
identify information associated with a likelihood that the HVAC system will fail in relation to a specific time based on the output of the machine learning model.

12. The system of claim 11, wherein the instructions further cause the one or more processors to:
access a schedule of a maintenance entity for maintaining the HVAC system; and
facilitate maintenance of the HVAC system based on the schedule of the maintenance entity and the information associated with the likelihood that the HVAC system will fail.

13. The system of claim 11, wherein the factors associated with operation of the HVAC system include a corresponding operational temperature of one or more components in relation to a corresponding target temperature of the one or more components during the operation of the HVAC system.

14. The system of claim 13, wherein the one or more components include an evaporator of the HVAC system, a battery chiller of a battery of the vehicle, a circuit of a computer system of the vehicle, or a combination thereof.

15. The system of claim 13, wherein the factors associated with operation of the HVAC system include an amount of battery power used in achieving the corresponding target temperature of the one or more components over time.

16. The system of claim 13, wherein the vehicle is part of a group of associated vehicles and the factors associated with operation of the HVAC system include factors associated with operation of HVAC systems of other vehicles in the group of associated vehicles.

17. The system of claim 16, wherein the group of associated vehicles is defined to include vehicles based on geographic similarity between locations of the vehicles.

18. The system of claim 11, wherein the information associated with the likelihood that the HVAC system will fail includes an identification of a component of the HVAC system for maintenance in correcting a potential failure in the HVAC system, and the instructions further cause the one or more processors to:
identify the component of the HVAC system based on the factors associated with operation of the HVAC system from the output of the machine learning model.

19. The system of claim 11, wherein the information associated with the likelihood that the HVAC system will fail includes a severity level of a potential failure in the HVAC system.

20. A non-transitory computer-readable storage medium having stored therein instructions which, when executed by one or more processors, cause the one or more processors to:
monitor factors associated with operation of a heating, ventilation, and air conditioning (HVAC) system in a vehicle;
apply, to a machine learning model, input data generated by monitoring the factors associated with the operation of the HVAC system in the vehicle, wherein the machine learning model is configured to predict a health of the HVAC system in relation to the operation of the HVAC system in the vehicle;
access an output of the machine learning model that is indicative of the health of the HVAC system; and
identify information associated with a likelihood that the HVAC system will fail in relation to a specific time based on the output of the machine learning model.
